(19) United States
(12) Patent Application Publication
(10) Pub. No.: US 2013/0220828 A1
(43) Pub. Date: Aug. 29, 2013

(54) PROCESS AND SYSTEM FOR PRODUCING AN ANOLYTE FRACTION

(71) Applicant: Stefan Fischlein, Ystad (SE)

(72) Inventor: Stefan Fischlein, Ystad (SE)

(73) Assignee: ANOLYTECH AB, Ystad (SE)

(21) Appl. No.: 13/881,968

(22) PCT Filed: Oct. 28, 2011
(86) PCT No.: PCT/SE2011/051288

§ 371 Date: Apr. 26, 2013

(30) Foreign Application Priority Data
Oct. 28, 2010 (SE) 1051119-4

(51) Int. Cl. C02F 1/461

(52) U.S. Cl. CPC C02F 1/461
USPC 205/743; 204/240

(57) ABSTRACT

The present invention relates to a method for preparing an anolyte preparation, said anolyte preparation being suitable as drinking water for domestic animals kept indoors, for example in a barn, a cowshed, pigsty, and/or a poultry house, comprising the steps of: a) providing incoming basic water (202); b) adding sodium chloride to said incoming water; c) conveying said sodium chloride-containing water of step b) through the cathode chamber (212) of the electrochemical reactor (216), and subsequently conveying at least a part of said water that has passed through the cathode chamber (212) through the anode chamber (224) while applying a voltage over a membrane (213) separating the cathode chamber (212) and the anode chamber (224) of the electrochemical reactor (216) and thereby leading an electrical current between said chambers, resulting in formation of an anolyte fraction in the anode chamber; and d) determining pH and ORP of the obtained anolyte fraction, characterized in that data regarding the electrical current through said membrane (213) is used to control addition of sodium chloride, and data regarding pH of the obtained anolyte fraction is used to control the amount said water that has passed through the cathode chamber (212) that shall be conveyed through the anode chamber, in such a way that the free available chlorine (FAC) content of the resulting water is in the range of 0.10-0.60 ppm. The invention also provides a system for carrying out the method.

### FIELD OF INVENTION

The present invention relates to a process for disinfecting an incoming basic water flow, where the disinfected water could be used as drinking water for live animals or for cleaning/disinfection. The process involves electrochemical activation of aqueous salt solutions. More specifically, the invention relates to a process of producing an additive to regular water obtained from wells at a farm site, where the additive is an anolyte that has been produced by electrolysis of aqueous sodium chloride in a membrane reactor.

### TECHNICAL BACKGROUND

Electrolysis processes of aqueous alkali chloride solutions for producing chlorine, hydrogen and alkali metal hydroxides are well-known in the art. One such process is disclosed in U.S. Pat. No. 4,108,742, wherein the electrolysis is carried out in a cell that has been divided into cathode and anode chambers by a cation exchange membrane. As one objective of the technology of U.S. Pat. No. 4,108,742 is to produce chlorine gas, the electrolysis reaction is run at a low pH.

Electrochemical activation or electro-activation of dilute salt solutions in water has been the subject matter of several prior patents and publications. The prior art commonly discloses the use of electrochemical activation to produce an anolyte solution and a catholyte solution. Those who are engaged in the art will appreciate that an anolyte solution has a positive oxidation-reduction potential (ORP) or redox potential, which is oxidizing and has microbiocidal properties. The catholyte solution, on the other hand, has a negative ORP, has dispersive and surface active properties and can be used as a reducing agent.

Salts used in the prior art almost exclusively refer to sodium chloride (NaCl) and in most prior art applications chloride-based salts are used in a diluted form. However, there are various applications in which anolyte or catholyte are used in an undiluted form, but in many of these applications a major disadvantage of chloride-based or chloride-derived activated solutions is that they are corrosive to the materials with which they come into contact. This is particularly intolerable in medical applications where the solutions typically could be used for cold sterilization of medical instruments.

One such sterilization technology is disclosed in GB, A, 1,428,920. According to this document, a bacteria-laden surface is disinfected by applying a solution of hypochlorous acid generated by electrolyzing an aqueous solution of NaCl at a pH within the range of 6-7. Another similar disinfection method is described in WO99/20129. An animal product is exposed to an electrochemically activated, anion-containing aqueous solution. As a consequence, potentially harmful and/or destroying microorganisms are killed and the shelf life of the animal product is prolonged.

It should be kept in mind that object of the technology disclosed in GB 1,428,920 as well as WO99/20129 is sterilization and thus to kill all microorganisms around. When carrying out such processes, presence of chlorine gas is not considered to be a serious drawback and substantial amounts of chlorine are indeed released. It has generally been considered to be much more important to achieve a high degree of sterilization than to protect the close environment from high doses of chlorine.

When breeding domestic animals such as cows, pigs and poultry, it is important to consider contamination of potentially harmful microorganisms. Typically, the environment in cowsheds, barns, pigsties and poultry-houses is very rich in microorganisms. Water is continuously provided. Both animal feed and drinking water vessels may be contaminated. Such contamination of pathogenic microorganisms could lead to health problems for the animals. Furthermore, water from local wells is often used as drinking water for such animals and often without any further treatment. It is a known fact that the quality and composition of such water is not constant but varies with time. It is also important to consider that domestic animals need a functional and beneficial microflora in their alimentary channel as well as a safe environment essentially free from toxic substances such as chlorine. Especially ruminants such as cattle, sheep and horses are highly dependent on a beneficial and stable microflora in their stomachs and intestines in order to be able to digest their natural feed. Addition of conventional antibiotic substances to fodder and drinking water leads to several problems. Firstly, there is a high risk for development of microbial resistance to such antibiotic substances. Secondly, antibiotic substances may cause allergy. Consequently, presence of antibiotic substances in meat, eggs and other food products may lead to allergic and anaphylactic reactions in humans and other animals eating these products. Presence of high amounts of chlorine gas in drinking water could also harm the domestic animals due to loss of beneficial microorganisms in the alimentary channel and toxic side effects.

Furthermore, as the environment in cowsheds, barns, pigsties and poultry houses is rich in microorganisms, there is also a need for cleaning and removing/killing harmful microorganisms from time to time. Using traditional biocides and/or antibiotic substances for that purpose may lead to contamination of food products as well as allergic problems and resistance development.

Accordingly, there is a need for a technology for reducing microorganisms in water and fodder in animal shelters such as cowsheds, barns, pigsties and poultry-houses, which does not harm the normal microflora of domestic animals, such as cows, sheep, pigs and poultry and which does not involve using toxic or antibiotic substances potentially causing undesired toxic effects, microbial resistance and allergy problems. Furthermore, there is a need for disinfecting agents that could be used for cleaning animal shelters such as cowsheds, barns, pigsties, and poultry houses without getting any of the above mentioned drawbacks.

### SUMMARY OF THE INVENTION

The above mentioned problems are solved by the subject matter of the claims.

The first object of the present invention is to provide a method for preparing an anolyte preparation, said anolyte preparation being suitable as drinking water for domestic animals kept indoors or as a cleaning liquid, for example in a barn, a cowshed, pigsty, and/or a poultry house, comprising the steps of:

a) providing incoming water;

b) adding sodium chloride to said incoming water;

c) conveying said sodium chloride-containing water of step b) through the cathode chamber of the electrochemical reactor, and subsequently conveying at least a part of said water that has passed through the cathode chamber through the anode chamber while applying a voltage over a membrane separating the cathode chamber and the anode chamber of the electrochemical reactor and thereby leading an electrical current between said chambers, resulting in formation of an anolyte fraction in the anode chamber; and

d) determining pH and ORP of the obtained anolyte fraction, wherein data regarding the electrical current through said membrane is used to control addition of sodium chloride, and data regarding pH of the obtained anolyte fraction is used to control the amount said water that has passed through the cathode chamber that shall be conveyed through the anode chamber, in such a way that the free available chlorine (FAC) content of the resulting water is in the range of 0.10-0.60 ppm.

The second object of the present invention is to provide a system for producing an anolyte fraction by electrolyzing an incoming basic water flow to which sodium chloride is added, said system comprising
optionally a flow sensor;
a means for adding sodium chloride to a basic water flow;
an electrochemical reactor comprising a cathode chamber an anode chamber, and a membrane separating said cathode and anode chambers;
an electrical current sensor;
a first proportioning valve and a second proportioning valve;
a pH probe;
optionally an ORP sensor;
a memory means; and
a control and calculation means;
said electrical current sensor being adapted for measuring the electrical current through the ceramic membrane, and being adapted for transferring data regarding the electrical current through the ceramic membrane to said control and calculation means;
said optional flow sensor if present being adapted for measuring the incoming basic water flow and transfer data regarding such flow to said control and calculation means;
said control and calculation means being adapted for controlling addition of sodium chloride from said means for adding sodium chloride to said basic water flow based on data obtained from said electrical current sensor and optionally said flow sensor;
said pH probe and optionally said ORP sensor being adapted for measuring pH data and optionally ORP data and to transfer said data to said control and calculation means;
said control and calculation means being adapted for regulating said first proportional valve and said second proportional valve in such a way that an analytic fraction is produced that has a pH value within the range of 6.0-7.0 and a free available chlorine (FAC) content of 0.10-0.60 ppm.

### DETAILED DESCRIPTION OF THE INVENTION

The present invention is based on the discovery that domestic animals, such as cattle, sheep, pigs and poultry, could be harmed if they are exposed to unnecessarily high amounts of chlorine gas. In fact, ruminants such as cattle and sheep are extra sensitive because their food digestion process is highly dependent on a beneficial and stable microflora in their stomach compartments and intestines. Loss of that microflora in addition to other toxic effects of chlorine could be fatal for a ruminant but it could also harm other domestic animals such as pigs and poultry.

Likewise, the environment of typical animal shelters, such as a cowshed, barn, pigsty or a poultry house, is extremely rich in microorganisms. It is occasionally necessary to remove harmful microorganisms from such an environment. Such an action, however, typically involves spreading biocidal chemicals in the environment. As a result, the animals may be contaminated with such chemicals.

In order to take care of the above mentioned problem with undesired microbial growth in drinking water, anolyte preparations have been used as disinfecting agents. In case the pH of the water is within the range of 6.0-7.0, chlorine in an anolyte is mostly present as hypochloric acid and not as chlorine gas. Furthermore, hypochloric acid is not stable at alkaline and acid pH and it is therefore beneficial to maintain a pH within the range of 6.0-7.0 in case high amount of hypochloric acid is desired.

Domestic animals at farms are often given water from local wells, lakes, rivers or streams. Typically, such water is not pretreated before giving it to the animals and its composition and pH may therefore vary with time. In case an anolyte would be added to such water without any further consideration, the resulting chlorine content could be far too high for the animals and they could be severely, if not fatally, harmed.

It has turned out to be beneficial to provide water having a pH within the range of 6.0-7.0, and where said water contains an anolyte fraction obtained by electrolysis of an aqueous solution of sodium chloride, and where it has a free available chlorine (FAC) content within the range of 0.10-0.60 ppm, as drinking water for domestic animals kept indoors for maintaining and/or improving their growth. Regarding ruminants such as cattle and sheep, it is preferred that the FAC content is within 0.14-0.40 ppm. Regarding other animals, such as pigs and poultry, it is preferred that the FAC content is within 0.4-0.6 ppm. FAC values below 0.10 ppm do not have a sufficient effect against undesired microbial growth and FAC values above 0.60 ppm may harm the animals.

Information regarding determination of FAC values, as well as tables of FAC as a function of pH and ORP (oxidation reduction potential) can be found in Technical Bulletin No. 24, issued by Aquarius Technologies Pty. Ltd. (AU) (http:/www.aquariustech.com.au/pdfs/tech-bulletins/Undrstnd Ox ORP.pdf)

The first objective of the present invention is to provide a method for preparing an anolyte preparation, said anolyte preparation being suitable as drinking water for domestic animals kept indoors, for example in a barn, a cowshed, pigsty, and/or a poultry house, comprising the steps of:

a) providing incoming water;

b) adding sodium chloride to said incoming water;

c) conveying said sodium chloride-containing water of step b) through the cathode chamber of the electrochemical reactor, and subsequently conveying at least a part of said water that has passed through the cathode chamber through the anode chamber while applying a voltage over a membrane separating the cathode chamber and the anode chamber of the electrochemical reactor and thereby leading an electrical current between said chambers, resulting in formation of an anolyte fraction in the anode chamber; and

d) determining pH and ORP of the obtained anolyte fraction, characterized in that data regarding the electrical current through said membrane is used to control addition of sodium chloride, and data regarding pH of the obtained anolyte fraction is used to control the amount said water that has passed through the cathode chamber that shall be conveyed through the anode chamber, in such a way that the free available chlorine (FAC) content of the resulting water is in the range of 0.10-0.60 ppm.

As herein disclosed, the terms “anolyte” and “catholyte” respectively, relates to fractions obtained in the chambers of an electrochemical flow reactor. The anolyte is produced in the anode chamber and the catholyte in the cathode chamber. The chambers of such an electrochemical flow reactor are typically separated by a membrane, such as a ceramic membrane.

The terms “incoming water” or “incoming basic water” relates to any kind of water that is available at a typical farm site.

The electrochemical reaction of the aqueous sodium chloride solution results in formation of an anolyte containing a high amount of hypochloric acid. A high voltage and a high original concentration of sodium chloride leads to a higher concentration of hypochloric acid. As is suggested above, hypochloric acid is not stable over a longer time period but decomposes back to a chloride salt over time. It is therefore advantageous to use the anolyte quite soon after it has been produced.

It is preferred that ions selected from the group of Fe²⁺, Fe³⁺, Mn²⁺and Ca²⁺, and optionally humus particles, are removed from the process water flow by suitable filters.

In a preferred embodiment, at least 40% of the water that has passed through the cathode chamber is conveyed through the anode chamber. Typically, 50-80% of such water is passed through the anode chamber,

In one preferred embodiment, the free available chlorine (FAC) content of the resulting water is within the range of 0.14-0.40 ppm. In another preferred embodiment, the FAC content is within the range of 0.40-0.60 ppm.

It is also preferred that catholyte is injected into the basic water flow at specific times. The catholyte fraction has a high content of anti-oxidants and it is believed that it stimulates the immune system of domestic animals. Typically, the catholyte fraction could be added at times when the animals are used to feed. Then, they drink much more than otherwise and hence, water is consumed so fast that there is not time for microbial contaminations to form.

In a second embodiment, the present invention provides a system for producing an anolyte fraction by electrolyzing an incoming basic water flow to which sodium chloride is added, said system comprising
optionally a flow sensor;
a means for adding sodium chloride to a basic water flow;
an electrochemical reactor comprising a cathode chamber an anode chamber, and a membrane separating said cathode and anode chambers;
an electrical current sensor;
a first proportioning valve and a second proportioning valve;
a pH probe;
optionally an ORP sensor;
a memory means; and
a control and calculation means;
said electrical current sensor being adapted for measuring the electrical current through the membrane, and being adapted for transferring data regarding the electrical current through the membrane to said control and calculation means;
said optional flow sensor if present being adapted for measuring the incoming basic water flow and transfer data regarding such flow to said control and calculation means;
said control and calculation means being adapted for controlling addition of sodium chloride from said means for adding sodium chloride to said basic water flow based on data obtained from said electrical current sensor and optionally said flow sensor;
said pH probe and optionally said ORP sensor being adapted for measuring pH data and optionally ORP data and to transfer said data to said control and calculation means;
said control and calculation means being adapted for regulating said first proportional valve and said second proportional valve in such a way that an analytic fraction is produced that has a pH value within the range of 6.0-7.0 and a free available chlorine (FAC) content of 0.10-0.60 ppm.

In one preferred embodiment, the free available chlorine (FAC) content of the resulting water is within the range of 0.14-0.40 ppm. In another preferred embodiment, the FAC content is within the range of 0.40-0.60 ppm.

All components of the system are standard components which should be well-known to the skilled person. Accordingly, the ORP sensor is typically a set of electrodes such as a reference electrode and a measuring electrode that is used to measure the oxidation reduction potential of an aqueous sample. It is referred to Technical Bulletin No. 24 from Aquarius Technologies Pty. Ltd. Above. Likewise, any electrode capable of measuring pH of an aqueous sample could be used. Furthermore, the injection means and waterflow sensor are also standard components. The memory means and the control & and calculation means constitute parts of a computer system set up to calculate how much anolyte that has to be added in order to obtain a resulting water having the desired characteristics.

The invention will now be described with reference to the enclosed figures, wherein:

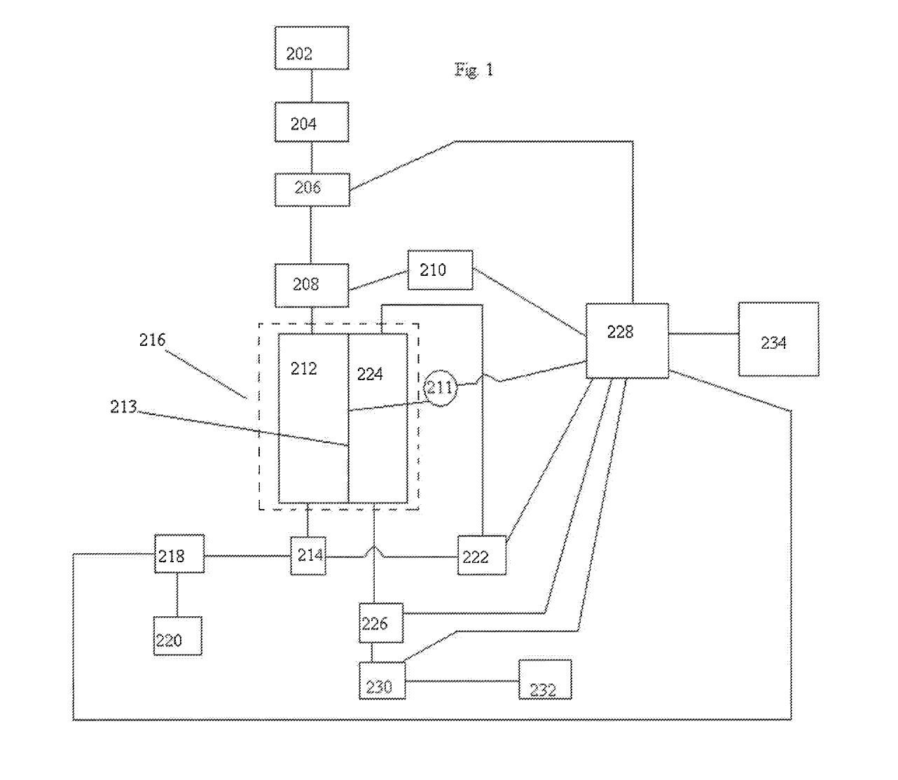

FIG. 1 discloses a sketch of the process according to a preferred embodiment of the second object of the present invention.

As already mentioned, the present invention relates to a method for preparing drinking water for domestic animals based on local incoming water. The incoming water typically originates from a well but may also originate from a river, lake or another water source. Referring to FIG. 1 and according to a preferred process embodiment 200 of the present invention, an incoming basic water flow 202 at a farm site and typically originating from a well, river, lake or another water source is conveyed towards a filter unit 204. Typically, filter unit 204 is assembled in response to a chemical analysis of the incoming water and may be adapted for absorbing humus/particles as well as ions, such as Ca2+, Fe2+, Fe3+and Mn2+. Flow sensor 206 monitors flow of the incoming basic flow and continuously transfers data to control and calculation means 228. Sodium chloride is forwarded from source 210 to a means 208 for adding sodium chloride to said flow. The resulting sodium chloride-containing water is lead into the catholyte chamber 212 (containing a cathode) of the reactor 216 and a catholyte fraction is formed. In addition to the cathode chamber 212, reactor 216 also comprises anode chamber 224 (containing an anode). The anode chamber is separated from the cathode chamber by a ceramic membrane 213. An electric current is lead through the ceramic membrane 213 and this current is monitored by an electrical current sensor 211. The catholyte fraction from cathode chamber is divided into two flows at branch point 214. One of these flows passes proportioning valve 218 and enters catholyte fraction tank 220. The other flow passes proportioning valve 222 and is forwarded to anode chamber 224 where the catholyte fraction is transformed into an anolyte fraction. The flow through the anolyte chamber 224 is parallel to the flow through the catholyte chamber 212. Subsequently, the anolyte fraction exits the anolyte chamber 224 and is passed by pH probe 226 and ORP probe 230 before it reaches anolyte fraction outlet 232.

The control and calculation means 228 receives electric current data from electric current sensor 211 and flow data from flow sensor 206. The control and calculation means controls addition of sodium chloride from source 210 to addition means 208, based on data from said electric current sensor 211 and information stored in memory means 234. A low current value implicates a larger addition of sodium chloride and a higher current value implicates a reduced addition of sodium chloride. The skilled person may easily adjust this regulation by routine experiments.

pH probe 226 and ORP sensor 230 continuously send data to the control and calculation means 228. Said means 228 controls proportioning valves 218 and 222 based on data from pH probe 226 and stored information in memory means 234. The pH should be maintained within the range of 6.0-7.0. A pH value under 6.0 implies that the catholyte flow through proportioning valve 218 should be increased and the flow through proportioning valve 222 and into the anolyte chamber 224 should be reduced. Similarly, a pH value above 7.0 implies that the flow through proportioning valve 218 should be reduced and the flow through proportioning valve 222 and into the anolyte chamber 224 should be increased. The skilled person may easily adjust this regulation by routine experiments.

Data from flow sensor 206, electric current sensor 211, pH probe 226 and ORP probe 230 may be stored in memory means 234.

It is to be understood that the invention is not limited in its application to the details of construction and arrangement of parts illustrated in the accompanying drawings, since the invention is capable of other embodiments and of being practiced or carried out in various ways. Also, it is to be understood that the phraseology or terminology employed herein is for the purpose of description and not for limitation.

1. A method for preparing an anolyte preparation, said anolyte preparation being suitable as drinking water for domestic animals kept indoors, for example in a barn, a cowshed, pigsty, and/or a poultry house, comprising the steps of:
a) providing incoming basic water (202);
b) adding sodium chloride to said incoming water;
c) conveying said sodium chloride-containing water of step b) through the cathode chamber (212) of the electrochemical reactor (216), and subsequently conveying at least a part of said water that has passed through the cathode chamber (212) through the anode chamber (224) while applying a voltage over a membrane (213) separating the cathode chamber (212) and the anode chamber (224) of the electrochemical reactor (216) and thereby leading an electrical current between said chambers, resulting in formation of an anolyte fraction in the anode chamber; and
d) determining pH and ORP of the obtained anolyte fraction, characterized in that data regarding the electrical current through said membrane (213) is used to control addition of sodium chloride, and data regarding pH of the obtained anolyte fraction is used to control the amount said water that has passed through the cathode chamber (212) that shall be conveyed through the anode chamber, in such a way that the free available chlorine (FAC) content of the resulting water is in the range of 0.10-0.60 ppm.

2. A method according to claim 1, characterized in that at least 40% of the water that has passed through the cathode chamber is conveyed through the anode chamber.

3. A method according to any of claims 1-2, characterized in that at least 50%, preferably 50-90% of the water that has passed through the cathode chamber is conveyed through the anode chamber.

4. A method according to anyone of claims 1-3, characterized in that the free available chlorine (FAC) content of the resulting water is in the range of 0.14-0.40 ppm.

5. A method according to anyone of claims 1-3, characterized in that the free available chlorine (FAC) content of the resulting water is in the range of 0.40-0.60 ppm.

6. A method according to anyone of claims 1-5, characterized in that ions selected from the group of Fe²⁺, Fe³⁺, Mn²⁺ and Ca²⁺, and optionally humus particles, are removed from the incoming water by suitable filters.

7. A system for producing an anolyte fraction by electrolyzing an incoming basic water flow to which sodium chloride is added, said system comprising
optionally a flow sensor (206);
a means (208) for adding sodium chloride to a basic water flow;
an electrochemical reactor (216) comprising a cathode chamber (212) an anode chamber (224), and a membrane (213) separating said cathode and anode chambers;
an electrical current sensor (211);
a first proportioning valve (218) and a second proportioning valve (222);
a pH probe (226);
optionally an ORP sensor (230);
a memory means (234); and
a control and calculation means (228);
said electrical current sensor (211) being adapted for measuring the electrical current through the membrane (213), and being adapted for transferring data regarding the electrical current through the membrane (213) to said control and calculation means (228);
said optional flow sensor (206) if present being adapted for measuring the incoming basic water flow and transfer data regarding such flow to said control and calculation means (228);
said control and calculation means (228) being adapted for controlling addition of sodium chloride from said means (208) for adding sodium chloride to said basic water flow based on data obtained from said electrical current sensor (211) and optionally said flow sensor (206);
said pH probe (226) and optionally said ORP sensor (230) being adapted for measuring pH data and optionally ORP data and to transfer said data to said control and calculation means (228);
said control and calculation means (228) being adapted for regulating said first proportional valve (218) and said second proportional valve (222) in such a way that an analytic fraction is produced that has a pH value within the range of 6.0-7.0 and a free available chlorine (FAC) content of 0.10-0.60 ppm.

8. A system according to claim 7, characterized in that said control and calculation means is set up to determine how much anolyte that has to be added in order to obtain a free available chlorine (FAC) content of the resulting water within the range of 0.14-0.40 ppm.

9. A system according to claim 7, characterized in that said control and calculation means is set up to determine how much anolyte that has to be added in order to obtain a free available chlorine (FAC) content of the resulting water within the range of 0.40-0.60 ppm.
